(19) United States
(12) Patent Application Publication
(10) Pub. No.: US 2018/0297820 A1
(43) Pub. Date: Oct. 18, 2018

(54) BELT OR BELT SEGMENT

(71) Applicant: ContiTech Transportbandsysteme GmbH, Hannover, DE (US)

(72) Inventors: Achim Huels, Barsinghausen (DE); Michael Moeschen-Siekmann, Noerten-Hardenberg (DE)

(21) Appl. No.: 16/011,341

(22) Filed: Jun. 18, 2018

Related U.S. Application Data
(63) Continuation of application No. PCT/EP2016/072404, filed on Sep. 21, 2016.

(30) Foreign Application Priority Data
Dec. 16, 2015 (DE) 10 2015 225 425.9

(51) Int. Cl. B66C 13/16; F16G 3/07; B66C 1/18; G01B 7/16; G01B 11/16; G01B 5/30

(52) U.S. Cl. CPC B66C 13/16; F16G 3/07; G01B 5/30; G01B 7/16; G01B 11/16; B66C 1/18

(57) ABSTRACT

The present disclosure relates to a belt or a belt segment having steel cables that run substantially in the longitudinal direction of the belt or belt segment and are disposed so as to be substantially mutually parallel, wherein the belt or the belt segment has at least one open end having a fastening device which via clamping is connected to at least one part of the steel cables. The belt or the belt segment is characterized by at least one measuring installation which is configured to detect a spacing (d) in the longitudinal direction (X) between the belt or the belt segment and the fastening device.

### CROSS REFERENCE TO RELATED APPLICATIONS

This application is a continuation application of international patent application PCT/EP2016/072404, filed Sep. 21, 2016, designating the United States and claiming priority from German application 10 2015 225 425.9, filed Dec. 16, 2015, and the entire content of both applications is incorporated herein by reference.

### BACKGROUND OF THE INVENTION

Belts or belt segments which are used for lifting or pulling loads have been know for a long time. To this end, belts or belt segments which have an open end to which the load to be lifted or pulled can be fastened can be used. For this purpose, the open end of the belt or belt segment is conventionally guided as a sling around a part or part-region of the load such as, for example a hook or the like.

The configuration of the sling or else loop herein is usually performed in such a manner that the open end of the belt or belt segment is folded back around the hook or the like such that the open end bears on a part-region of the belt or belt segment, and the two regions thereon are pressed onto one another by clamping. A force-fitting connection is established on account thereof.

Sling-type clamped belt connections of this type can be slowly released over time in that the folded-back open end begins to creep until the latter has been fully released from the clamping. The belt is then torn away from the load.

In order for this procedure that usually progresses slowly to be identified in a timely manner prior to the load being torn away, it is commonplace in the case of belt connections of this type for the latter to be regularly inspected, for example by a person. The progressing creep of the folded-back open end herein can be reliably identified, for example, in that at least one marking is provided on the belt surface, in relation to which a relative movement in the belt direction can be visually identified in a simple and reliable manner. On account thereof, a gradual release of the belt connection can be identified by a person, and, for example, a termination of the application, a replacement of the belt, or a renewal of the clamping connection can be arranged in a timely fashion.

In the case of a belt or a belt segment having steel cables that run substantially in the longitudinal direction of the belt or belt segment and are disposed so as to be substantially mutually parallel, it is known from U.S. Pat. No. 9,447,843 B2 for a fastening device which via clamping is connected to at least one part of the steel cables to be disposed as an alternative belt connection on at least one open end. To this end, the steel cables can be introduced into respective openings of the fastening device and therein be compressed from the outside such that a force-fitting clamping connection which can transmit 100% of the cable load at breakage can be established between the fastening device and the steel cables.

It is disadvantageous herein that the monitoring of the quality of the cable connection of a folded-back open end of a belt as described above cannot be applied to a clamping connection of this type of a fastening device because no relative movement of the folded-back open end can take place on the surface of the belt. Rather, a gradual release of the belt connection occurs within the fastening device in that the ends of the steel cables slowly slip out of the openings of the fastening device. This cannot be identified by a person by way of an optical marking on the belt surface.

### SUMMARY OF THE INVENTION

It is an object of the invention to provide a belt or a belt segment such that a release of a clamping connection of a fastening device can be identified. This is able to be identified in particular in an automatic manner. The intention is to achieve at least an alternative to known possibilities.

The object can, for example, be achieved via a belt or belt segment having: a plurality of steel cables; a belt body or belt segment body defining a longitudinal direction (X); the steel cables running substantially in the longitudinal direction and being disposed so as to be substantially mutually parallel; the belt body or belt segment body having an open end; a fastening device disposed at the open end and connected to at least one part of the plurality of steel cables via clamping; and, at least one measuring installation configured to detect a spacing (d) in the longitudinal direction (X) between the belt body or belt segment body and the fastening device.

The belt or belt segment is characterized by at least one measuring installation which is configured to detect a spacing in the longitudinal direction between the belt or the belt segment and the fastening device. All types of sensor which can detect a spacing, or a distance, respectively can be considered as a measuring installation. The detection of a spacing herein is also to be understood as detecting a change in the spacing which can be detected via a tear-away sensor, for example.

The present disclosure herein is based on the concept that a measuring installation can be used for monitoring or detecting, respectively, a relative movement of the connection partners of a clamping connection. Automatic and continuous monitoring can be performed in this way such that impermissible weakening of the clamping connection can be reliably identified at an early stage. Already minute changes can also be identified. This can enhance the safety in the application of a belt or belt segment having a clamped fastening device.

According to an aspect of the present invention, the measuring installation has at least one sensor unit which is disposed on the fastening device, and at least one sensor counter piece which is disposed on the belt or belt segment, respectively, or vice versa. If the sensor unit and the sensor counter piece are in each case fixedly connected to the fastening device, or to the belt or belt segment, respectively, no relative movement can in each case occur between the sensor unit and the fastening device, and between the sensor counter piece and the belt or belt segment, respectively. If, therefore, a spacing or a change in a spacing, respectively, which exceeds a predetermined limit value, for example, is detected, a relative movement of the fastening device in relation to the belt or belt segment can thus be identified on account thereof, and the conclusion of a weakening of the clamping connection can thus be drawn.

The sensor unit herein can be disposed on the fastening device, and the sensor counter piece can be disposed on the belt or belt segment, or the sensor unit can be disposed on the belt or belt segment, and the sensor counter piece can be disposed on the fastening device.

According to a further aspect of the present invention, the sensor unit is an electrically measuring sensor, in particular an eddy current sensor, and the sensor counter piece is an electrically conductive body, in particular a metallic body. In this way, a non-contacting detection of the spacing or of a change in the spacing, respectively, can take place by way of an inductive measurement. This type of measurement can be very robust in relation to contaminations such as, for example, dust and the like, such that the type of measurement can be very suitable for respective applications in which contaminating environmental influences are to be taken into account.

According to a further aspect of the present invention, the sensor unit is a tactile sensor and the sensor counter piece is a rigid or yielding body. A detection of the spacing, or the detection of a change in the spacing, respectively, can also take place in this way. The sensor counter piece, being rigid or yielding, herein is to be configured or disposed, respectively, in such a manner that a predetermined spacing, or a predetermined critical change in the spacing, respectively, is achieved, at which a predetermined critical spacing value or spacing change value, respectively, is exceeded when the tactile contact is terminated, for example.

According to a further aspect of the invention, the sensor unit is an optical sensor and the sensor counter piece is an optically reflecting body. A detection of the spacing, or the detection of a change in the spacing, respectively, can also take place in this way. To this end, a spacing measurement or distance measurement, respectively, via a laser can be used, for example.

According to a further aspect of the invention, the sensor unit is a tear-away sensor which in the longitudinal direction is connected to a counter piece so as to be capable of being torn away from the latter. A detection of the spacing, or the detection of a change in the spacing, respectively, can also take place in this way. A tear-away sensor can act in that an interruption of an electrical circuit on account of a change in length or a relative movement, respectively, can be caused and detected.

According to a further aspect of the invention, the measuring installation, in particular a computer unit of the measuring installation that is connected in a signal-transmitting manner to the sensor unit, is configured to emit a predetermined signal should the spacing detected exceed a predetermined limit value. A reaction to the detection of a predetermined spacing or of a predetermined change in the spacing, respectively, can take place in this way. For example, a warning signal which, for example, can cause a personal inspection of the clamping connection by a person can be emitted or initiated, respectively. The application can also be stopped or closed down, respectively, by a signal so as to avoid safety risks. Alternatively or additionally, optical and/or acoustic warning signals can also be emitted in order to warn about the safety risks.

According to a further aspect of the invention, the belt or the belt segment substantially has an elastomeric material in which the steel cables are embedded as strength members. A flexible belt, or a flexible belt segment, respectively, can be provided on account thereof.

According to a further aspect of the invention, the clamping device has a plurality of openings into which the steel cables are introduced and are clamped therein. The connection of the fastening device on the belt or belt segment can be improved on account thereof. A more uniform transmission of force between the steel cables of the belt or of the belt segment and the fastening device can also be achieved. The durability of the clamping connection can be improved in either case.

### BRIEF DESCRIPTION OF THE DRAWINGS

The invention will now be described with reference to the drawings wherein:

FIG. 1 shows a perspective schematic illustration of a belt or belt segment, having a clamped fastening device and a measuring installation; and,

FIG. 2 shows a lateral schematic illustration of FIG. 1.

### DESCRIPTION OF THE PREFERRED EMBODIMENTS OF THE INVENTION

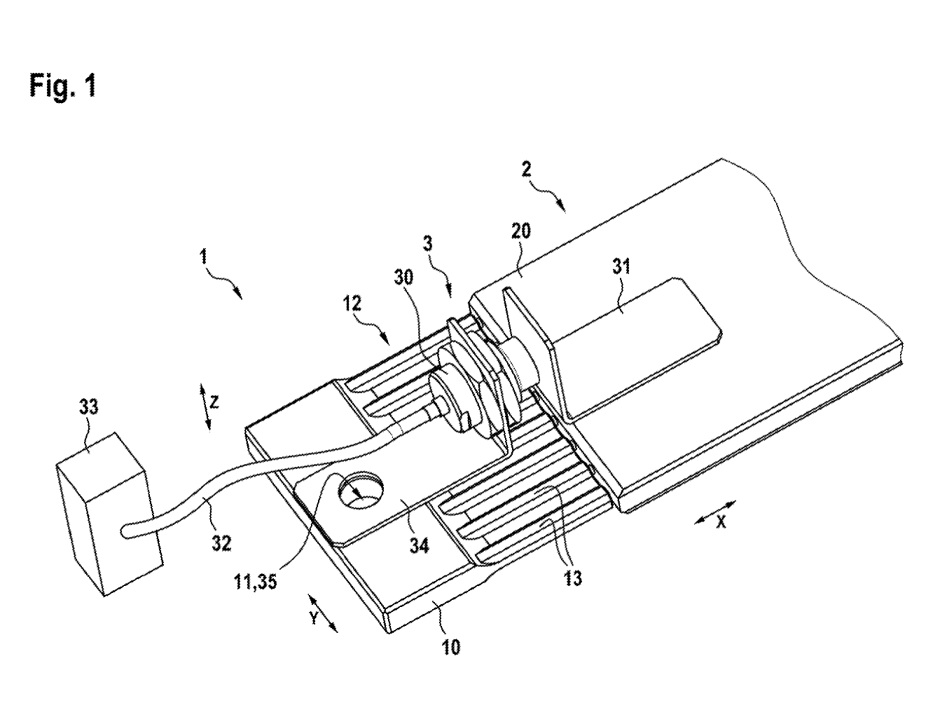

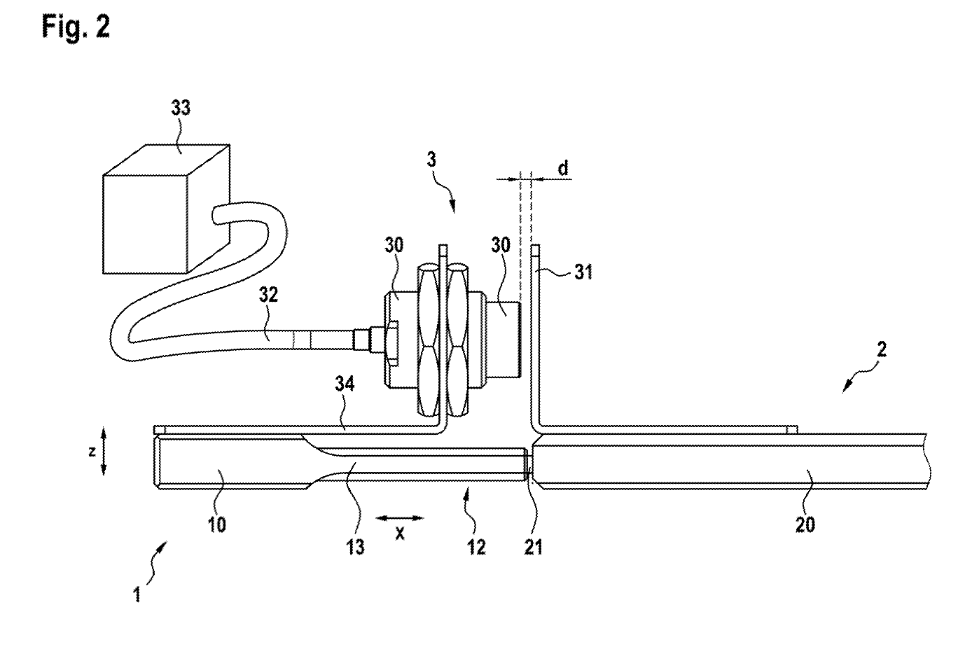

FIG. 1 shows a perspective schematic illustration of a belt 2 or belt segment 2, having a clamped fastening device 1 and a measuring installation 3. FIG. 2 shows a lateral schematic illustration of FIG. 1.

The fastening device 1 and the belt 2, or the belt segment 2, respectively, extend substantially in a longitudinal direction X which can also be referred to as the length X. A transverse direction Y, which can also be referred to as the width Y, extends perpendicularly thereto. A vertical direction Z which can also be referred to as the height Z or the thickness Z extends to the two directions X, Y.

The fastening device 1 has a first part-region 10 which can also be referred to as the head piece 10 of the fastening device 1. The head piece 10 is connected to a second part-region 12 which can also be referred to as the clamping piece 12 of the fastening device 1. The head piece 10 and the clamping piece 12 are interconnected and configured in such a manner that both can reliably transmit the forces between a load and a belt 2 or belt segment 2. The head piece 10 and the clamping piece 12 in the present embodiment are provided so as to be made from steel and in an integral manner, that is, so as to be solid, made from one body.

The head piece 10 has a connection element 11 which, for example, can be a hook or the like. The connection element 11 in the embodiment illustrated is a clearance 11 which runs perpendicularly to the longitudinal direction X of the belt 2 or belt segment 2, respectively, and perpendicularly to the plane of the belt 2 or belt segment 2, respectively. By means of this clearance 11, which can also be referred to as the opening 11 or as the through bore 11, the head piece 10 of the fastening device 1 can be hooked into to a hook or a protrusion of a load, or else a mounting, or else be screw-fitted to a load or mounting.

The clamping piece 12 has a clamping device 13 which in the embodiment illustrated is composed of a plurality of clamping webs 13 which in the interior thereof have in each case at least one opening in the form of a longitudinal bore (not illustrated) that runs in the longitudinal direction X. The steel cables 21 of the belt 2 or belt segment 2, respectively, are held so as to be clamped in the longitudinal bores. To this end, a force has been applied externally to the clamping webs 13 such that the diameter or cross-section, respectively, of the longitudinal bores of the clamping webs 13 has been constricted in such a manner that a force-fitting clamping connection has been established between the interior of the longitudinal bores, and thus the clamping webs 13, and the steel cables 21, the force-fitting clamping connection being able to bear the load of the connection element 11. The steel cables 21 within the belt 2 or the belt segment 2, respectively, are embedded in the elastomeric belt body 20 of the latter.

A measuring installation 3 is provided in order for the durability of the force-fitting clamping connection of the steel cables 21 in the longitudinal bores of the clamping webs 13 to now be monitored. The measuring installation 3 has a sensor unit 30 in the form of an eddy current sensor 30 which is disposed on the fastening device 1 and in the longitudinal direction X is aligned toward the belt 2, or toward the belt segment 2, respectively. The measuring installation 3 furthermore has a sensor counter piece 31 in the form of a metallic body 31 which is disposed so as to be bent back at a right angle on the surface of the belt 2 or belt segment 2, respectively. The metallic body 31 by way of the face thereof that is bent upright in the longitudinal direction X is aligned toward the eddy current sensor 30 and disposed at a predetermined spacing d from the latter.

The eddy current sensor 30 is disposed on the fastening device 1 via a mounting 34 that is likewise bent upright. To this end, the mounting 34 has a clearance 35 which can be moved so as to be congruent with the clearance 11 of the head piece 10, such that the eddy current sensor 30 via the mounting 34 thereof can be disposed conjointly with the load to be handled on the fastening device 1 and can be fixedly screwed thereto, for example.

The eddy current sensor 30 via a signal transmission line 32 is connected in a signal-transmitting manner to a computer unit 33 of the measuring installation 3. The detected spacing d can be evaluated via the computer unit 33. On account thereof, it is possible for the detected spacing d to be compared with a predetermined limit value. Alternatively, a spacing differential can be determined from the currently detected spacing d and the previously detected spacing d, and the spacing differential can be compared with a predetermined limit value. In any case, automated and continuous monitoring of the durability of the clamping connection can take place in this way, such that a releasing clamping connection can be detected at an early stage. As a reaction thereto, measures can be initiated, for example in order for a user to be warned to refrain from using the application, or for an inspection or else a repair of the clamping connection by persons to be initiated, respectively.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Specification

d Measured spacing in the longitudinal direction X between the sensor unit 30 and the sensor counter piece 31

X Longitudinal direction, length

Y Transverse direction, width

Z Vertical direction, height, thickness

1 Fastening device

10 First part-region, or head piece, respectively, of the fastening device 1

11 Connection element, or clearance, respectively, of the head piece 10

12 Second part-region, or clamping piece, respectively, of the fastening device 1

13 Clamping device, or clamping webs, respectively, of the clamping piece 12

2 Belt, belt segment

20 Belt body, belt segment body

21 Steel cables

3 Measuring installation

30 Sensor unit, eddy current sensor, tactile sensor, optical sensor

31 Sensor counter piece, metallic body, rigid body, reflecting body

32 Signal transmission line of the sensor unit 30 to the computer unit 33

33 Computer unit

34 Mounting of the sensor unit 30

35 Clearance of the mounting 34

What is claimed is:

1. A belt or belt segment comprising:
a plurality of steel cables;
a belt body or belt segment body defining a longitudinal direction (X);
said steel cables running substantially in the longitudinal direction (X) and being disposed so as to be substantially mutually parallel;
said belt body or belt segment body having an open end;
a fastening device disposed at said open end and connected to at least one part of said plurality of steel cables via clamping; and,
at least one measuring installation configured to detect a spacing (d) in the longitudinal direction (X) between said belt body or belt segment body and said fastening device.

2. The belt or belt segment of claim 1, wherein said measuring installation includes at least one sensor unit disposed on said fastening device and at least one sensor counter piece which is disposed on said belt body or belt segment body or vice versa.

3. The belt or belt segment of claim 2, wherein said sensor unit is an electrically measuring sensor, and said sensor counter piece is an electrically conductive body.

4. The belt or belt segment of claim 3, wherein said electrically measuring sensor is an eddy current sensor.

5. The belt or belt segment of claim 3, wherein said electrically conductive body is a metallic body.

6. The belt or belt segment of claim 2, wherein said sensor unit is a tactile sensor and the sensor counter piece is a rigid or yielding body.

7. The belt or belt segment of claim 2, wherein said sensor unit is an optical sensor and the sensor counter piece is an optically reflecting body.

8. The belt or belt segment of claim 2, wherein said sensor unit is a tear-away sensor which, in the longitudinal direction (X), is connected to said counter piece so as to be capable of being torn away from the latter.

9. The belt or belt segment of claim 1, wherein said measuring installation is configured to emit a predetermined signal if the detected spacing (d) exceeds a predetermined limit value.

10. The belt or belt segment of claim 1, wherein said belt body or belt segment body includes an elastomeric material in which said plurality of steel cables are embedded as strength members.

11. The belt or belt segment of claim 1, wherein said fastening device has a plurality of openings into which said plurality of steel cables are introduced and are clamped therein.

12. The belt or belt segment of claim 9, wherein:
said measuring installation includes at least one sensor unit disposed on said fastening device and at least one sensor counter piece which is disposed on said belt body or belt segment body or vice versa; and,
said measuring installation includes a computer unit connected to said sensor unit in a signal-transmitting manner.
